(19) United States
(12) Patent Application Publication
(10) Pub. No.: US 2010/0321408 A1
(43) Pub. Date: Dec. 23, 2010

(54) Viewpoint Compensation for Curved Display Surfaces in Projector-Based Display Systems

(76) Inventors: Sean Miceli, San Jose, CA (US); Victor Ivashin, Danville, CA (US); Steve Nelson, San Jose, CA (US)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 12/488,355

(22) Filed: Jun. 19, 2009

(51) Int. Cl. G09G 5/00

(52) U.S. Cl. 345/643

(57) ABSTRACT

Methods having corresponding apparatus and tangible computer-readable media comprise: generating a second image based on a first image and a viewpoint transform, wherein the viewpoint transform represents a mapping between pixel locations of the first image and coordinates of a model of a curved display surface; and generating a third image based on the second image and a projection transform, wherein the projection transform represents a mapping between the coordinates of the model of the curved display surface and pixel locations of a projector; wherein the third image is projected upon the curved display surface by the projector.

### FIELD

The present disclosure relates generally to projector-based display systems. More particularly, the present disclosure relates to viewpoint compensation for curved display surfaces in projector-based display systems.

### BACKGROUND

One challenge in creating projector-based display systems is compensating for geometric distortions such as keystoning caused by misalignment of the projector and the display surface, radial dispersion of light, and the like. For clarity, these types of distortions are referred to herein as “projection distortions.” An additional challenge arises when the display surface is curved. The curvature of the display surface can cause highly viewpoint-dependent geometric distortions. That is, the geometric distortions appear to vary significantly based on viewpoint. For clarity, these types of distortion are referred to herein as “viewpoint distortions.” FIGS. 1-2 conceptually illustrate one kind of viewpoint distortion. For clarity, projection distortions are assumed to have been compensated in FIGS. 1-2.

In each of FIGS. 1-2, a simple image 102 consisting of seven equally-spaced vertical lines is projected upon a display surface that is shown as viewed from above. In FIG. 1 the display surface 104 is planar. Therefore in the projection on display surface 104, adjacent lines are separated by a uniform distance. For example, the distance d12 between the first and second lines is the same as distance d67 between the sixth and seventh lines (d12=d67).

This is not the case when the same image 102 is projected in the same way upon a curved display surface. Referring to FIG. 2, adjacent lines are separated by varying distances in the projection upon curved display surface 106. For example, the distance d12 between the first and second lines is significantly greater than the distance d67 between the sixth and seventh lines (d12>d67). This distortion appears to vary with viewpoint. For example, from the viewpoint of the projector, the distortion would not be apparent. However, from other viewpoints the distortion would be readily apparent. For example, from a viewpoint to the right of the projector, the left side of the projected image would appear stretched when compared to the right side.

### SUMMARY

In general, in one aspect, an embodiment features tangible computer-readable media embodying instructions executable by a computer to perform a method comprising: generating a second image based on a first image and a viewpoint transform, wherein the viewpoint transform represents a mapping between pixel locations of the first image and coordinates of a model of a curved display surface;

and generating a third image based on the second image and a projection transform, wherein the projection transform represents a mapping between the coordinates of the model of the curved display surface and pixel locations of a projector; wherein the third image is projected upon the curved display surface by the projector.

Embodiments of the tangible computer-readable media can include one or more of the following features. In some embodiments, the method further comprises: generating the viewpoint transform. In some embodiments, generating the viewpoint transform comprises: generating the model of the curved display surface. In some embodiments, the method further comprises: generating the projection transform. In some embodiments, generating the second image comprises: rendering the second image based on the first image. In some embodiments, rendering the second image comprises: modifying vertices of the first image according to the viewpoint transform. In some embodiments, generating the third image comprises: rendering the third image based on the second image. In some embodiments, rendering the third image comprises: modifying fragments of the second image according to the projection transform.

In general, in one aspect, an embodiment features an apparatus comprising: a viewpoint module adapted to generate a second image based on a first image and a viewpoint transform, wherein the viewpoint transform represents a mapping between pixel locations of the first image and coordinates of a model of a curved display surface; and a projection module adapted to generate a third image based on the second image and a projection transform, wherein the projection transform represents a mapping between the coordinates of the model of the curved display surface and pixel locations of a projector; wherein the third image is projected upon the curved display surface by the projector.

Embodiments of the apparatus can include one or more of the following features. Some embodiments comprise a viewpoint transform module adapted to generate the viewpoint transform. In some embodiments, the viewpoint transform module comprises: a model module adapted to generate the model of the curved display surface. Some embodiments comprise a projection transform module adapted to generate the projection transform. In some embodiments, the viewpoint module comprises: a render module adapted to render the second image based on the first image. In some embodiments, the render module comprises: a vertex shader adapted to modify vertices of the first image according to the viewpoint transform. In some embodiments, the projection module comprises: a render module adapted to render the third image based on the second image. In some embodiments, the render module comprises: a fragment shader adapted to modify fragments of the second image according to the projection transform.

In general, in one aspect, an embodiment features a method comprising: generating a second image based on a first image and a viewpoint transform, wherein the viewpoint transform represents a mapping between pixel locations of the first image and coordinates of a model of a curved display surface; and generating a third image based on the second image and a projection transform, wherein the projection transform represents a mapping between the coordinates of the model of the curved display surface and pixel locations of a projector; wherein the third image is projected upon the curved display surface by the projector.

Embodiments of the method can include one or more of the following features. Some embodiments comprise generating the viewpoint transform. In some embodiments, generating the viewpoint transform comprises: generating the model of the curved display surface. In some embodiments, wherein generating the second image comprises: rendering the second image based on the first image. In some embodiments, rendering the second image comprises: modifying vertices of the first image according to the viewpoint transform. In some embodiments, generating the third image comprises: rendering the third image based on the second image. In some embodiments, rendering the third image comprises: modifying fragments of the second image according to the projection transform.

The details of one or more implementations are set forth in the accompanying drawings and the description below. Other features will be apparent from the description and drawings, and from the claims.

### DESCRIPTION OF DRAWINGS

FIGS. 1-2 conceptually illustrate one kind of viewpoint distortion. In FIG. 1 the display surface is planar. In FIG. 2 the display surface is curved.

FIG. 3 conceptually illustrates one example of viewpoint compensation.

FIG. 4. conceptually illustrates a two-step approach for viewpoint compensation according to embodiments of the present disclosure.

FIG. 5 shows a projection system according to some embodiments.

FIG. 6 shows a process for the projection system of FIG. 5 according to some embodiments.

FIG. 7 shows a multi-projector system according to some embodiments.

FIG. 8 shows a process for the multi-projector system of FIG. 7 according to some embodiments.

The leading digit(s) of each reference numeral used in this specification indicates the number of the drawing in which the reference numeral first appears.

### DETAILED DESCRIPTION

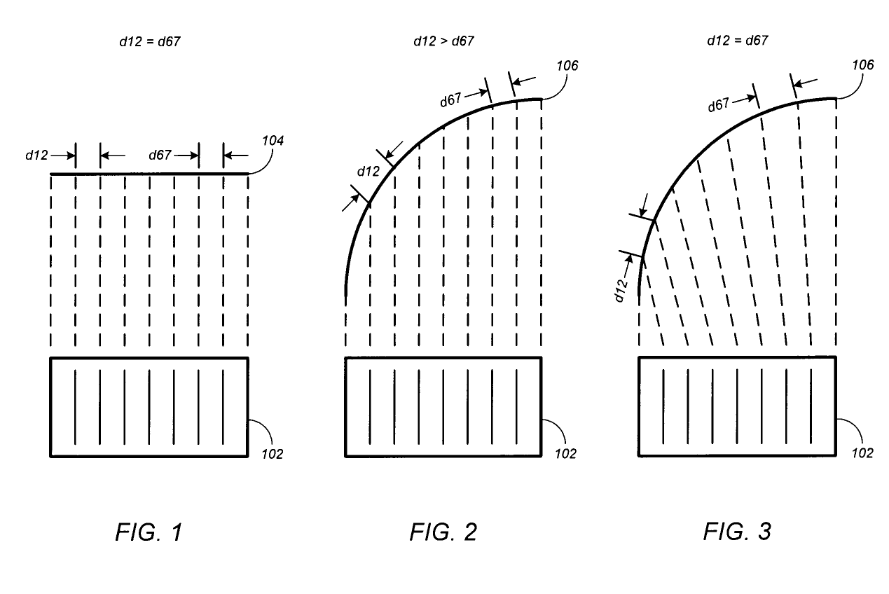

Embodiments provide viewpoint compensation for curved display surfaces in projector-based display systems. FIG. 3 conceptually illustrates one example of viewpoint compensation. For clarity, projection distortions are assumed to have been compensated in FIG. 3. In FIG. 3, the projection of image 102 has been compensated so that the distances between adjacent lines are equal in the projection of image 102 upon curved display surface 106 (d12=d67). Therefore the geometric distortion caused by curved display surface 106 is independent of viewpoint.

FIG. 3 illustrates only one example of viewpoint compensation for one kind of curved display surface. However, embodiments are not limited by this example. Various embodiments can be employed to obtain other sorts of viewpoint compensation, and to use other sorts of curved display surfaces. For example, the viewpoint compensation can be employed to obtain desired viewpoint-dependent compensation. In addition, more complex display surfaces can be employed, for example having multiple curves, curves in other or multiple dimensions, and the like. Embodiments can also be used with planar display surfaces.

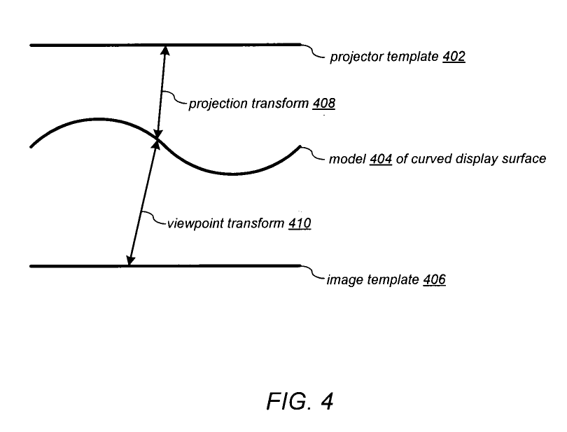

Embodiments of the present disclosure provide a two-step approach that is conceptually illustrated in FIG. 4. FIG. 4 depicts an image template 406, a model 404 of a curved display surface, and a projector template 402. Image template 406 defines pixel locations of images to be projected. For example, image template 406 can define the total number of pixels in images to be projected, dimensions of the image in pixels, pixel layout, and the like. Projector template 402 defines pixel locations of a projector. For example, projector template 402 can define the total number of pixels to be projected (that is, the resolution of the projector), the dimensions of the projection in pixels, pixel layout, and the like. Model 404 can be a two-dimensional or three-dimensional computer model of the curved display surface. For example, model 404 can be a mesh of points each representing a point on the curved display surface.

Embodiments provide two transforms: a viewpoint transform 410 and a projection transform 408. Viewpoint transform 410 represents a mapping between pixel locations of image template 406 and coordinates of model 404. Projection transform 408 represents a mapping between coordinates of model 404 and pixel locations of projector template 402. Viewpoint transform 410 is used to compensate for viewpoint distortion, while projection transform 408 is used to compensate for projection distortion.

One advantage of using two separate transforms 408, 410 is that a viewpoint transform 410 for a particular curved display surface can be modified or exchanged for another viewpoint transform 410 for that particular curved display surface without changing the projection transform 408 for that curved display surface. Therefore the viewpoint compensation can be modified without the need for re-generating projection transform 408. In embodiments of the present disclosure, generation of the projection transform 408 is independent of generation of the viewpoint projection transform 410.

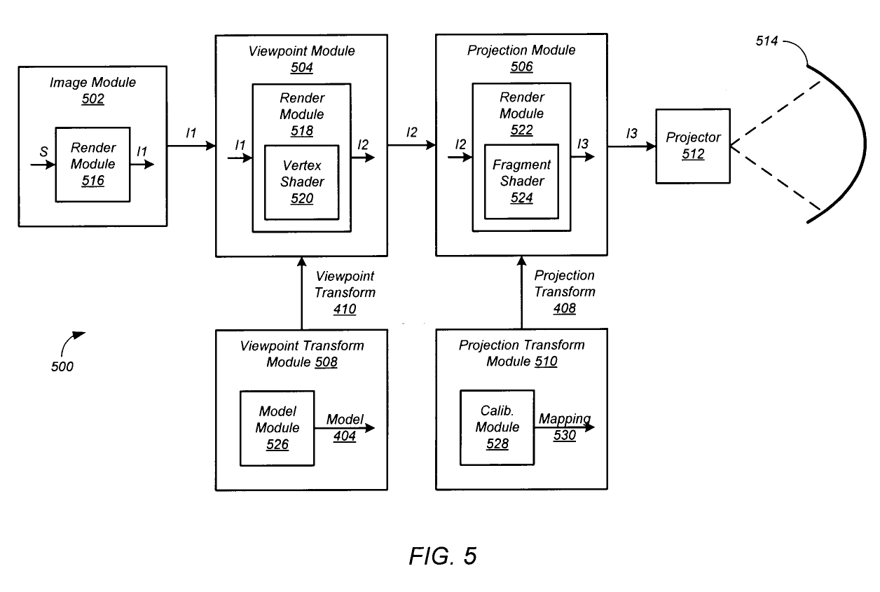

FIG. 5 shows a projection system 500 according to some embodiments. Although in the described embodiments, the elements of projection system 500 are presented in one arrangement, other embodiments may feature other arrangements, as will be apparent to one skilled in the relevant arts based on the disclosure and teachings provided herein. For example, the elements of projection system 500 can be implemented in hardware, software, or combinations thereof.

Referring to FIG. 5, projection system 500 includes an image module 502, a viewpoint module 504, a projection module 506, a viewpoint transform module 508, a projection transform module 510, a projector 512, and a curved display screen 514. Image module 502 includes a render module 516. Viewpoint module 504 includes a render module 518 that includes a vertex shader 520. Projection module 506 includes a render module 522 that includes a fragment shader 524. Viewpoint transform module 508 includes a model module 526. Projection transform module 510 includes a calibration module 528.

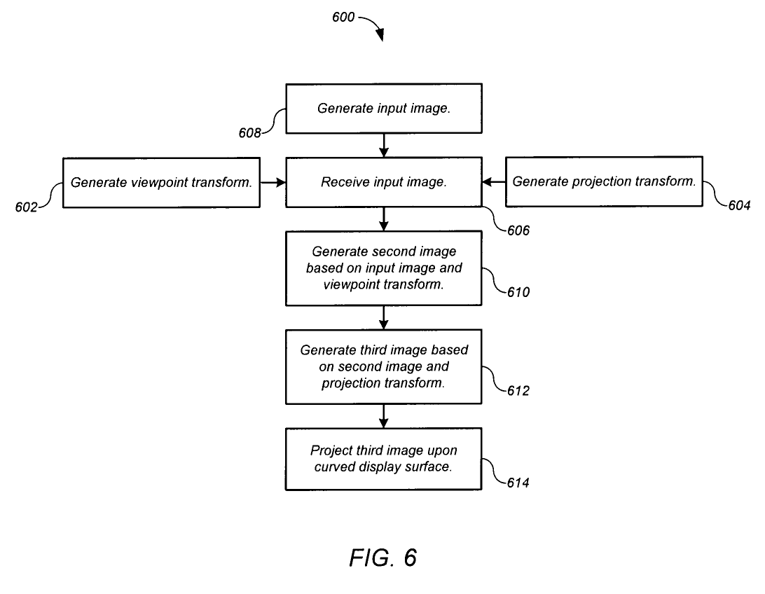

FIG. 6 shows a process 600 for projection system 500 of FIG. 5 according to some embodiments. Although in the described embodiments, the elements of process 600 are presented in one arrangement, other embodiments may feature other arrangements, as will be apparent to one skilled in the relevant arts based on the disclosure and teachings provided herein. For example, in various embodiments, some or all of the steps of process 600 can be executed in a different order, concurrently, and the like.

Referring to FIG. 6, viewpoint transform module 508 generates a viewpoint transform 410 (step 602). In particular, model module 526 generates a model 404 of curved display surface 514. Model 404 can be generated several different ways. For example, model 404 can be generated based on a mathematical function representing the geometry of curved display surface 514. As another example, model 404 can be generated using measurements of the geometry of curved display surface 514. Viewpoint transform module 508 then generates viewpoint transform 410 based on model 404. In particular, viewpoint transform module 508 then creates a mapping between pixel locations of image template 406 and coordinates of model 404. Viewpoint transform 410 represents the mapping.

Projection transform module 510 generates a projection transform 408 (step 604). In particular, calibration module 528 generates a calibration mapping 530. For example, projector 512 can project a digital calibration image upon curved display surface 514. A digital representation of the projection of the digital calibration image can be captured, for example by a digital camera. Calibration module 528 then generates calibration mapping 530 between pixels of the digital representation of the projection and pixels of the digital calibration image. Projection transform 408 represents calibration mapping 530. Conventional techniques can be used to generate projection transform 408.

Viewpoint module 504 receives an input image I1 (step 606). In some cases, image I1 is generated by image module 502 (step 608). In some cases, render module 516 of image module 502 renders image I1 based on a scene S. For example, scene S can be an OpenGL scene. Render module 516 renders the OpenGL scene to a texture. The texture is image I1. In other cases, image module 502 can generate image I1 in other ways. In some cases, image I1 is simply provided as a bitmap image or the like. Image I1 conforms to image template 406.

Viewpoint module 504 generates a second image I2 based on image I1 and viewpoint transform 410 (step 610). Viewpoint transform 410 represents a mapping between pixel locations of image I1 and coordinates of model 404 of curved display surface 514. For example, render module 518 of viewpoint module 504 renders image I2 based on image I1 and viewpoint transform 410. In some embodiments, viewpoint transform 410 is implemented by vertex shading during rendering. In these embodiments, render module 518 includes a vertex shader 520 that modifies the vertices of image I1 during rendering according to viewpoint transform 410. For example, OpenGL or the like can be used for the rendering. The rendering can be performed by a graphics processing unit of a video card or the like.

Projection module 506 generates a third image I3 based on image I2 and projection transform 408 (step 612). Projection transform 408 represents a mapping between the coordinates of model 404 of curved display surface 514 and pixel locations of projector 512. For example, render module 522 of projection module 506 renders image I3 based on image I2 and projection transform 408. In some embodiments, projection transform 408 is implemented by fragment shading during rendering. In these embodiments, render module 522 includes a fragment shader 524 that modifies the fragments of image I2 during rendering according to projection transform 408. For example, OpenGL or the like can be used for the rendering. The rendering can be performed by a graphics processing unit of a video card or the like.

Projector 512 projects image I3 upon curved display surface 514 (step 614). Image I3 conforms to projector template 402.

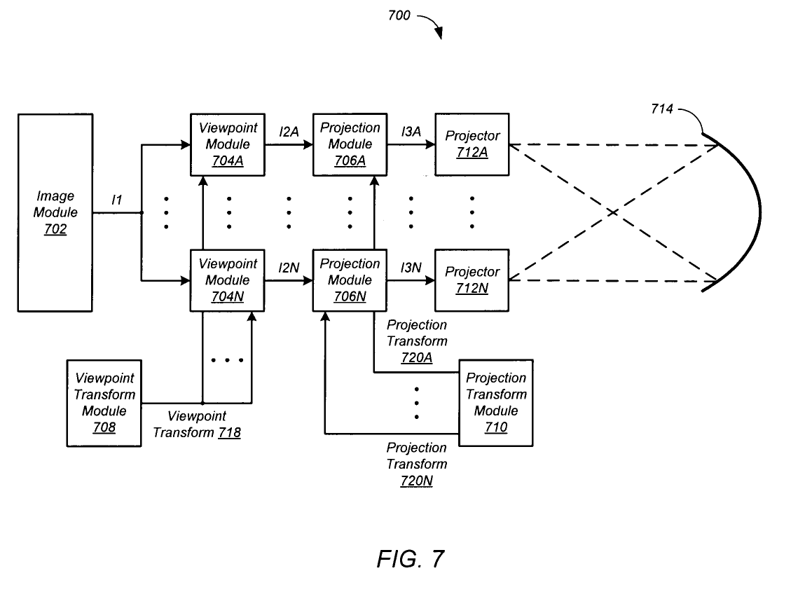

In some embodiments, projector 512 is implemented as multiple projectors, for example in order to produce a tiled display where each projector projects a different portion of an image, to produce a super-bright display where the projections overlap in order to obtain a very bright projection, and the like. FIG. 7 shows a multi-projector system 700 according to some embodiments. Although in the described embodiments, the elements of multi-projector system 700 are presented in one arrangement, other embodiments may feature other arrangements, as will be apparent to one skilled in the relevant arts based on the disclosure and teachings provided herein. For example, the elements of multi-projector system 700 can be implemented in hardware, software, or combinations thereof. Referring to FIG. 7, multi-projector system 700 includes an image module 702, N viewpoint modules 704A-704N, N projection modules 706A-706N, a viewpoint transform module 708, a projection transform module 710, N projectors 712A-712N, and a curved display screen 714. These modules can be implemented as described above.

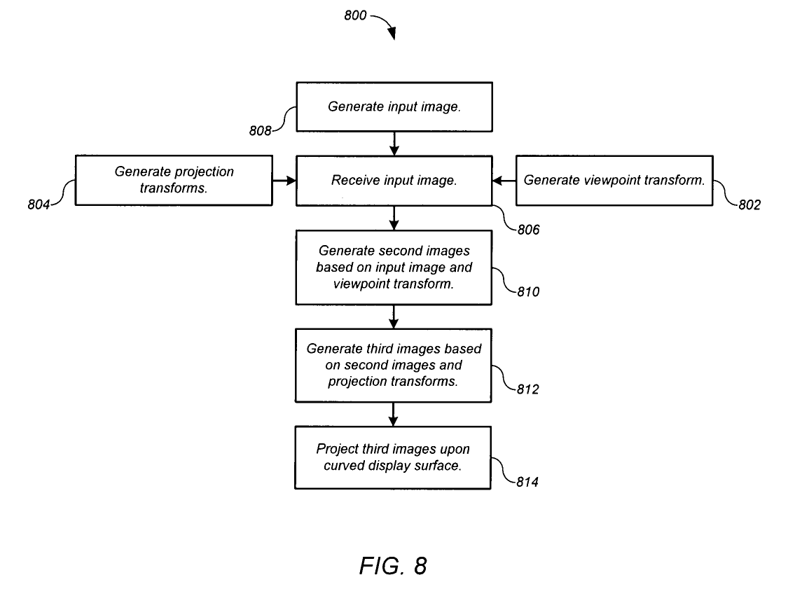

FIG. 8 shows a process 800 for multi-projector system 700 of FIG. 7 according to some embodiments. Although in the described embodiments, the elements of process 800 are presented in one arrangement, other embodiments may feature other arrangements, as will be apparent to one skilled in the relevant arts based on the disclosure and teachings provided herein. For example, in various embodiments, some or all of the steps of process 800 can be executed in a different order, concurrently, and the like.

Referring to FIG. 8, viewpoint transform module 708 generates a viewpoint transform 718 (step 802), for example as described above. Projection transform module 710 generates N projection transforms 720A-720N (step 804), one for each of projectors 712A-712N. Because a projection transform 720 is specific to its projector 712, a different projection transform 720 is employed for each projector 712. Each projection transform 720 can be generated as described above.

Each viewpoint module 704 receives the same input image I1 (step 806). In some cases, image I1 is generated by image module 702 (step 808), for example as described above. Each of viewpoint modules 704A-704N generates a respective second image 12A-12N based on image I1 and viewpoint transform 718 (step 810), for example as described above. For increased efficiency, each viewpoint module 710 can operate upon only that portion of image I2 to be projected by the corresponding projector 712.

Each of projection modules 706A-706N generates a respective third image 13A-13N based on the respective second image 12A-12N and the respective projection transform 720A-720N (step 812), for example as described above. Each of projectors 712A-712N projects the respective image 13A-13N upon curved display surface 714 to form a single composite image (step 814).

Various embodiments can be implemented in digital electronic circuitry, or in computer hardware, firmware, software, or in combinations of them. Apparatus can be implemented in a computer program product tangibly embodied in a machine-readable storage device for execution by a programmable processor; and method steps can be performed by a programmable processor executing a program of instructions to perform functions by operating on input data and generating output. Embodiments can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

A number of implementations have been described. Nevertheless, it will be understood that various modifications may be made without departing from the spirit and scope of this disclosure. Accordingly, other implementations are within the scope of the following claims.

What is claimed is:

1. Tangible computer-readable media embodying instructions executable by a computer to perform a method comprising:
generating a second image based on a first image and a viewpoint transform, wherein the viewpoint transform represents a mapping between pixel locations of the first image and coordinates of a model of a curved display surface; and
generating a third image based on the second image and a projection transform, wherein the projection transform represents a mapping between the coordinates of the model of the curved display surface and pixel locations of a projector;
wherein the third image is projected upon the curved display surface by the projector.

2. The tangible computer-readable media of claim 1, wherein the method further comprises:
generating the viewpoint transform.

3. The tangible computer-readable media of claim 2, wherein generating the viewpoint transform comprises:
generating the model of the curved display surface.

4. The tangible computer-readable media of claim 1, wherein generating the second image comprises:
rendering the second image based on the first image by modifying vertices of the first image according to the viewpoint transform.

5. The tangible computer-readable media of claim 1, wherein generating the third image comprises:
rendering the third image based on the second image by modifying fragments of the second image according to the projection transform.

6. An apparatus comprising:
a viewpoint module adapted to generate a second image based on a first image and a viewpoint transform, wherein the viewpoint transform represents a mapping between pixel locations of the first image and coordinates of a model of a curved display surface; and
a projection module adapted to generate a third image based on the second image and a projection transform, wherein the projection transform represents a mapping between the coordinates of the model of the curved display surface and pixel locations of a projector;
wherein the third image is projected upon the curved display surface by the projector.

7. The apparatus of claim 6, further comprising:
a viewpoint transform module adapted to generate the viewpoint transform.

8. The apparatus of claim 7, wherein the viewpoint transform module comprises:
a model module adapted to generate the model of the curved display surface.

9. The apparatus of claim 6, wherein the viewpoint module comprises:
a render module adapted to render the second image based on the first image.

10. The apparatus of claim 9, wherein the render module comprises:
a vertex shader adapted to modify vertices of the first image according to the viewpoint transform.

11. The apparatus of claim 6, wherein the projection module comprises:
a render module adapted to render the third image based on the second image.

12. The apparatus of claim 11, wherein the render module comprises:
a fragment shader adapted to modify fragments of the second image according to the projection transform.

13. A method comprising:
generating a second image based on a first image and a viewpoint transform, wherein the viewpoint transform represents a mapping between pixel locations of the first image and coordinates of a model of a curved display surface; and
generating a third image based on the second image and a projection transform, wherein the projection transform represents a mapping between the coordinates of the model of the curved display surface and pixel locations of a projector;
wherein the third image is projected upon the curved display surface by the projector.

14. The method of claim 13, further comprising:
generating the viewpoint transform.

15. The method of claim 14, wherein generating the viewpoint transform comprises:
generating the model of the curved display surface.

16. The method of claim 13, wherein generating the second image comprises:
rendering the second image based on the first image by modifying vertices of the first image according to the viewpoint transform.

17. The method of claim 13, wherein generating the third image comprises:
rendering the third image based on the second image by modifying fragments of the second image according to the projection transform.
